(19) United States
(12) Patent Application Publication
(10) Pub. No.: US 2013/0098211 A1
(43) Pub. Date: Apr. 25, 2013

(54) Extension Handle for Wrenches

(71) Applicant: Terre L. Sampson, SR., Las Vegas, NV (US)

(72) Inventor: Terre L. Sampson, SR., Las Vegas, NV (US)

(21) Appl. No.: 13/279,369

(22) Filed: Oct. 24, 2011

(51) Int. Cl. B25B 23/16; B25G 1/10

(52) U.S. Cl. 81/177.2

(57) ABSTRACT

An extension handle for wrenches with a rigid elongate member, a shaft member and a magnet member. The rigid elongate member has a top U shaped slot and a bottom oval shaped slot. The shaft member extends horizontally through the walls of the rigid elongate member and across the space created by the slots. The magnet is embedded in the side wall of the rigid elongate member near the open end of the U shaped slot. A preferred embodiment includes the rigid elongate member is injection molded of glass filled nylon. The magnet helps hold the wrench while in the wrench extending handle.

### CROSS REFERENCE TO RELATED APPLICATIONS

Not Applicable

### STATEMENT REGARDING FEDERALLY SPONSORED RESEARCH OR DEVELOPMENT

Not Applicable

### Description of Attached Appendix Not Applicable

### BACKGROUND OF THE INVENTION

This invention relates generally to the field of portable hand tool accessories and more specifically to an extension handle for wrenches. Standard open ended wrenches are used to tighten or loosen nuts that are screwed onto bolts. For nuts that are rusted in place, or for nuts that need an extra degree of tightening, it would be helpful to have a wrench handle extender to increase the leverage force on the nut.

To this end, a number of inventors have proposed various types of wrench extenders. For example, M Morgan, in his Pat. No. 1,643,027 issued in 1927, discloses an extension handle for wrenches that is made of forged metal and has an offset portion that engages one end of a double sided open ended wrench and a cradle that supports the central portion of the main body of the wrench, with an extension arm that extends beyond the wrench itself creating an extended lever arm for tightening or loosening a nut. However, there is a deficiency in the prior art in that the wrench being held in the cradle may slip thereby causing the end of the engaged portion of the wrench to disengage. Additionally, the embodiment shown is relatively expensive to manufacture in that the forging or metal casting process takes time and the materials used are relatively expensive. The resulting tool is also relatively heavy and therefore more difficult to transport along with a standard set of wrenches.

### BRIEF SUMMARY OF THE INVENTION

The primary object of the invention is to provide an extension handle for wrenches that is easy and economical to manufacture.

Another object of the invention is to provide an extension handle for wrenches that uses a magnet to help hold the wrench in place.

Another object of the invention is to provide an extension handle for wrenches that is relatively light weight and easy to transport.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an extension handle for wrenches comprising: a rigid elongate member, a shaft member, a magnet member, said rigid elongate member having a top U shaped slot and a bottom oval shaped slot, said shaft member extending horizontally through the walls of said rigid elongate member and across the space created by said slots, and said magnet embedded in said side wall of said rigid elongate member near the open end of said U shaped slot.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of the invention.

FIG. 3 is a perspective view of the invention in use.

FIG. 4 is a top view of the invention.

FIG. 5 is a bottom view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

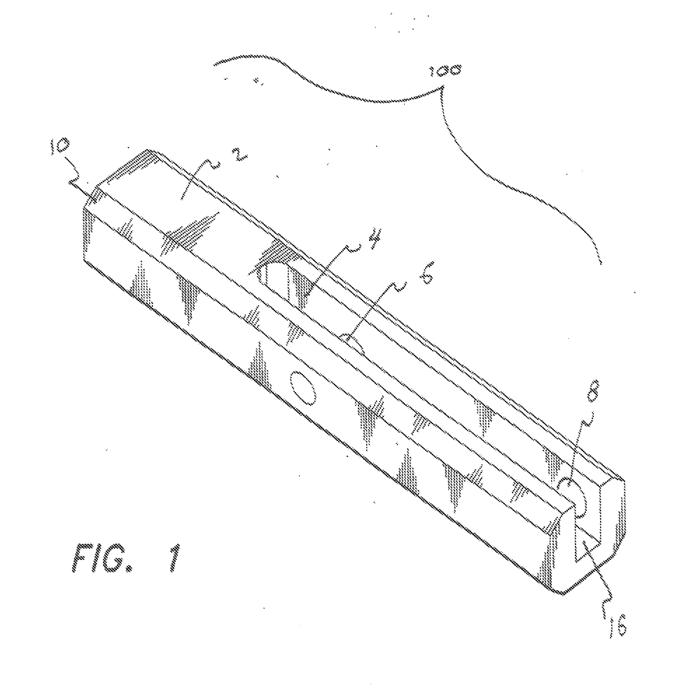

Referring now to FIG. 1 we see a perspective view of the invention 100. The wrench extending handle of the present invention 100 is essentially an rigid elongate member 2 that is mitered on each edge 10. The approximately one inch square cross section of the elongate member 2 plus the mitered edges 10 make the invention 100 easy to grasp because the user's finger joints and fingers naturally align with each miter 10 and each flat surface of the elongate member 2. The preferred length of elongate member 2 is approximately six inches, making it easy to carry, with a set of standard wrenches, to a job site. A U shaped slot 4 extends down to a floor member 16. A shaft 6 travels through the side walls of the U shaped slot 4 across the space formed by the slot 4. A magnet 8 is embedded in the side wall near the open end of the U shaped slot 4.

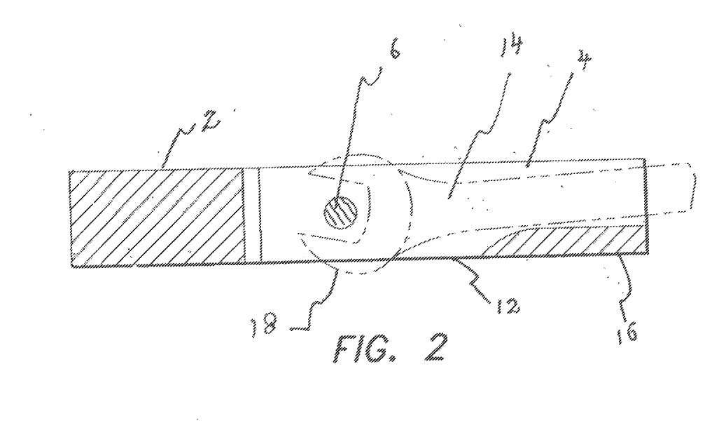

FIG. 2 shows a section view of the invention 100 that bisects the elongate member 2 in the long direction. A cross section view of the shaft 6 can be seen as the open end portion of a wrench 14 engages the shaft 6. An oval shaped slot 12 is located on the underside of the elongate member 2 leaving solid lower wall 16 as a rest for the main body of the wrench 14.

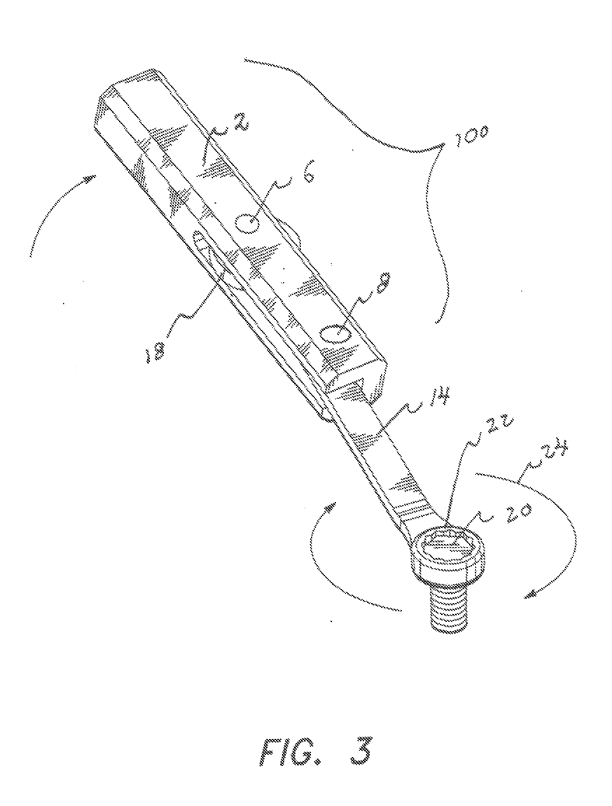

The perspective view in FIG. 3 shows the invention 100 in use. The open end of wrench 14 has engaged shaft 6. The magnet 8 is press fit into a molded aperture in the elongate member 2 and helps retain the main body of the wrench which has a ferrous iron content and keeps the wrench from slipping just before and during use. The closed end of the wrench 22 is about to tighten or loosen bolt head 20 as shown by radial arrow indicator 24. In this configuration, the user can rotate the extended handle 2 in the clockwise direction to tighten bolt head 20. If the user wants to loosen bolt head 20, he or she can turn the elongate handle 2 over one hundred and eighty degrees and then rotate the extended handle 2 in a counter clockwise direction. In the preferred embodiment, the elongate handle 2 is injection molded of glass filled nylon which as similar properties of steel but is lighter and less expensive to manufacture. The simple construction of the extension handle 100 makes it easy to mold and makes the tooling cost of the mold relatively inexpensive. Of course, the extension handle of the present invention 100 can be made of metal, such as aluminum or steel.

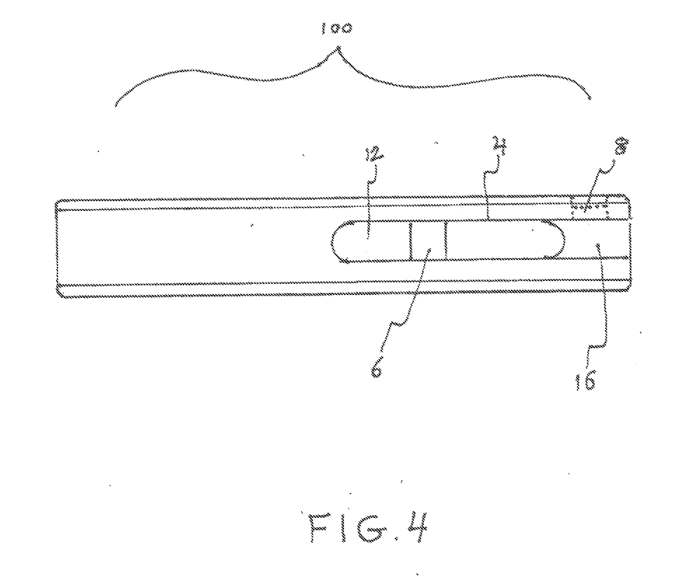

FIG. 4 is a top view of the invention 100 and shows the relationship of the oval opening 12 to the U shaped opening 4. The remaining floor portion 16 is clearly shown and is the surface that the wrench body 14 rests against when in use.

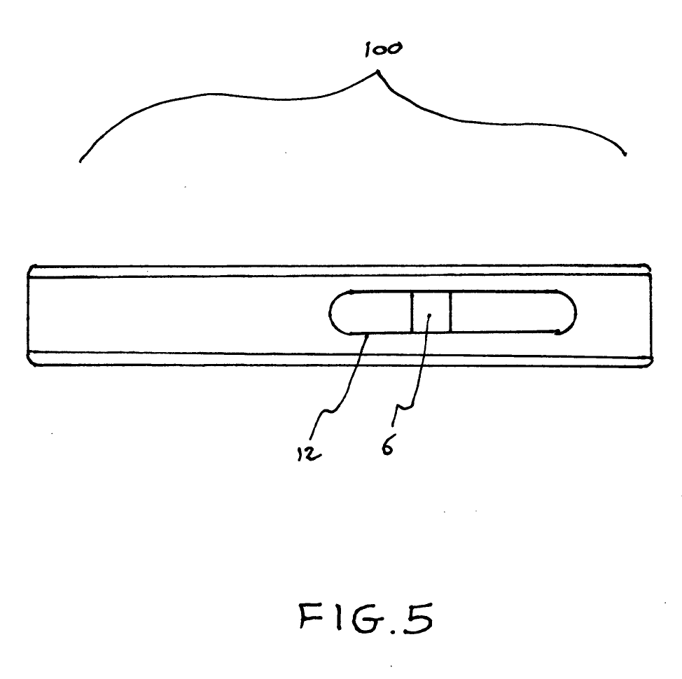

FIG. 5 is a bottom view of the invention 100 that clearly shows the oval opening 12 and shaft 6.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. extension handle for wrenches comprising:
a rigid elongate member;
a shaft member;
a magnet member;
said rigid elongate member having a top U shaped slot and a bottom oval shaped slot;
said shaft member extending horizontally through the walls of said rigid elongate member and across the space created by said slots; and
said magnet embedded in said side wall of said rigid elongate member near the open end of said U shaped slot.

2. extension handle for wrenches as claimed in claim 1 wherein said rigid elongate member is injection molded of glass filled nylon.

3. extension handle for wrenches as claimed in claim 1 wherein said rigid elongate member is approximately six inches long and one inch square in cross section.

4. extension handle for wrenches as claimed in claim 1 wherein said slots are approximately three eighths of an inch wide.

5. extension handle for wrenches as claimed in claim 1 wherein the section of wall between the end of said oval slot and the end of said elongate panel can actively engage the central portion of a standard wrench for the purpose of applying a greater amount of tightening or loosening force to a nut than would be otherwise be obtained by the use of said wrench by itself.
